(19) United States
(12) Patent Application Publication
(10) Pub. No.: US 2024/0220744 A1
(43) Pub. Date: Jul. 4, 2024

(54) LAMINATED COMPONENT HAVING TWO-DIMENSIONAL CODE PRINTED THEREON

(71) Applicant: FANUC CORPORATION, Yamanashi (JP)

(72) Inventor: Ryuya YASUDA, Yamanashi (JP)

(21) Appl. No.: 18/556,091

(22) PCT Filed: May 19, 2021
(86) PCT No.: PCT/JP2021/019004

§ 371 Date: Oct. 19, 2023

(51) Int. Cl. G06K 1/12; H01F 27/24; H02K 1/16; H02K 1/26

(52) U.S. Cl. CPC G06K 1/121; H01F 27/24; H02K 1/16; H02K 1/26

(57) ABSTRACT

This laminated component, which is configured by laminating thin sheets, is such that a two-dimensional code is printed, at a prescribed angle in the lamination direction of the thin sheets, on a laminated surface formed due to the sides of the thin sheets being laminated.

### TECHNICAL FIELD

The present invention relates to a stacked component on which a two-dimensional code is printed.

### BACKGROUND ART

Conventionally, from a viewpoint of traceability of a component, a so-called two-dimensional code such as a QR code (registered trademark) has been printed on a component in general, (see Patent Literatures 1 and 2, and the like, for example). By reading the printed two-dimensional code, it is possible to trace information such as identification information on respective components, information on a manufacturer, information on a manufacturing lot number, and information on a manufacturing date and time. Further, information on a distribution route, information relating to a maintenance history and the like of the components are sequentially stored in a cloud server or the like on a network. The information can be looked up based on identification information of the components as a key. As a result, reliability of information on the components can be improved and, at the same time, the forgery of the information on the components can be prevented.

### CITATION LIST

### Patent Literature

Patent literature 1 JP 2018-180777 A
Patent literature 2 JP 2001-113758 A

### SUMMARY OF INVENTION

### Technical Problem

A two-dimensional code can be easily printed by being printed on an approximately flat surface of a component having an area of an appropriate size. Further, a two-dimensional code printed on a substantially flat surface can be easily read because the light and dark portions reflect light substantially uniformly.

Depending on a kind of a component, there exists a component not having a flat surface that can be easily observed from the outside when the component is operated and large enough to print a two-dimensional code. FIG. 6 is a perspective view illustrating a stator (stacked component) included in an electric motor. The stacked component 1 is formed by stacking a plurality of metal thin plates 2 each being formed in a circular annular shape. Each of the thin plates 2 is provided with a plurality of protruding portions 3 that protrude inward in the circular annular shape. The thin plates 2 are stacked at the position where the respective protruding portions 3 overlap with each other.

In assembling the stacked component 1 in the electric motor, a coil is mounted on the protruding portions 3 in an overlapping manner and, thereafter, a flange is mounted on an upper surface 11 and a lower surface 12 of a core block. As described above, the upper surface 11 and the lower surface 12 of the core block are not exposed to the outside in an in-use state. In the case of printing a two-dimensional code on such a stacked component, a surface of the stacked component where a surface that the side portions of the plurality of stacked thin plates 2 form, that is, a stacked surface 13 is exposed to the outside is a surface that is closest to a flat surface. Accordingly, a two-dimensional code is printed on the stacked surface 13. By printing the two-dimensional code on the stacked surface 13, the two-dimensional code can be easily read even after the coil is mounted and the flanges are mounted. As described above, in a case where a two-dimensional code is printed on a stacked component such as a core block used as a stator or a rotor that an electric motor includes or a core block of a transformer, it is often necessary to print a two-dimensional code on stacked surfaces.

However, when the two-dimensional code is printed on the stacked surface, because of streaks each formed between the stacked thin plates, there exists a drawback that the two-dimensional code may not be clearly printed. Further, there also exists a drawback that, at the time of reading the printed two-dimensional code, it is difficult to read the two-dimensional code due to the reflection of a light at the streaks.

### Solution to Problem

It is an object of the present disclosure to provide a stacked component on which a two-dimensional code is printed that can overcome the above-mentioned drawbacks by inclining a printing direction of the two-dimensional code with respect to streaks formed on stacked surface of the stacked component.

According to one aspect of the present disclosure, there is provided a stacked component formed by stacking thin plates, wherein a two-dimensional code is printed on a stacked surface formed by stacking side portions of the thin plates in an inclined manner at a predetermined angle with respect to a stacking direction of the thin plates.

### Advantageous Effects of Invention

According to one aspect of the present disclosure, printing of a two-dimensional code is facilitated, and an error in reading the two-dimensional code is also reduced.

### BRIEF DESCRIPTION OF DRAWINGS

FIG. 1 is a perspective view illustrating a stacked component according to an embodiment of the present invention.

FIG. 2 is a perspective view illustrating a stacked component according to another embodiment of the present invention.

FIG. 3 is a schematic diagram illustrating a two-dimensional code.

FIG. 4 is a diagram illustrating an example of a two-dimensional code printed at an angle with respect to streaks formed on a stacking surface.

FIG. 5 is a diagram illustrating a positional relationship between dark cells and streaks in a case where a two-dimensional code is printed at an angle with respect to the streaks.

FIG. 6 is a perspective view illustrating a stator included in an electric motor.

### DESCRIPTION OF EMBODIMENTS

Hereinafter, embodiments of the present invention will be described with reference to the drawings.

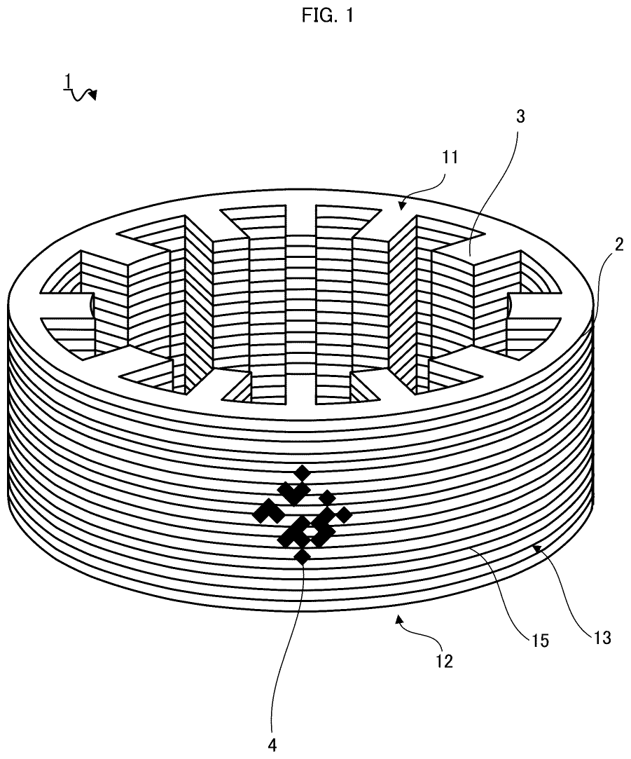

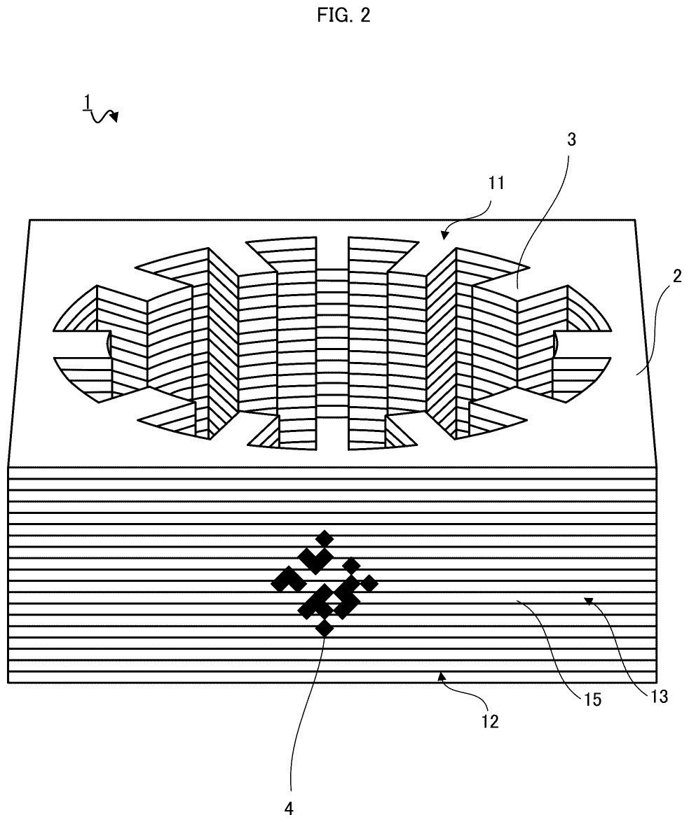

FIG. 1 is a perspective view illustrating a stacked component according to an embodiment of the present invention. FIG. 1 illustrates a circular stator included in an electric motor as an example of the stacked component 1. FIG. 2 illustrates a polygonal (rectangular) stator included in an electric motor as an example of the stacked component 1. The stacked component 1 may be, besides a core block used as a stator or a rotor included in an electric motor, any component such as a core block of a transformer provided that the stacked component 1 is formed by stacking thin plate-shaped members. The stacked component 1 is, as described above, formed by stacking the plurality of metal thin plates 2 each being formed in a circular annular shape. In the stacked component 1 according to the present embodiment, a two-dimensional code 4 is printed on a stacked surface 13 formed by stacking a plurality of thin plates 2. The characteristic configuration of the stacked component 1 according to the present embodiment lies in that the two-dimensional code 4 is printed on the stacked surface 13 in an inclined manner at a predetermined angle with respect to streaks 15 each formed between the thin plate 2 and the thin plate 2 on the stacked surface 13. In other words, the two-dimensional code 4 is printed on the stacked surface 13 of the stacked component 1 in an inclined manner at a predetermined angle with respect to the stacking direction of the thin plates 2.

The two-dimensional code 4 may be printed by directly transferring or spraying a dark color ink onto the stacked surface 13 by a thermal transfer method or an inkjet method, for example. Further, printing may be performed by directly engraving the two-dimensional code 4 on the stacked surface 13 using a laser engraving machine. As the two-dimensional code 4, for example, a two-dimensional code of a general matrix method such as a QR code (registered trademark), DataMatrix, or MaxiCode can be used.

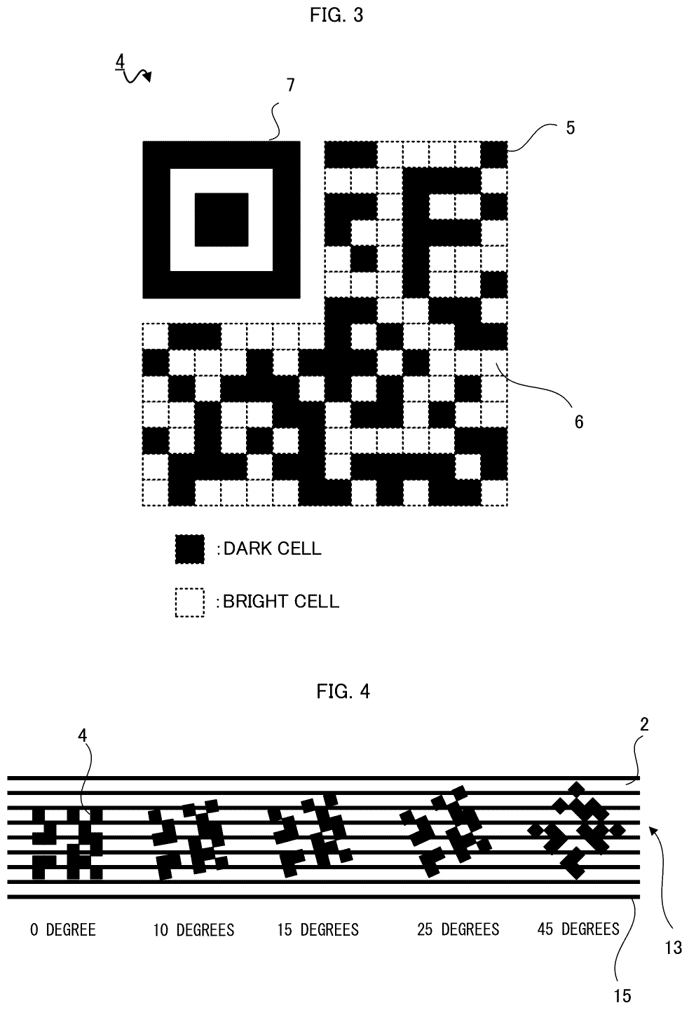

FIG. 3 is a schematic diagram illustrating a two-dimensional code. In general, the two-dimensional code is formed in a rectangular shape in which a plurality of cells are arranged in a lattice pattern. Each cell has a square profile and reflects light at a predetermined reflectance on a surface thereof. In the two-dimensional code 4 illustrated in FIG. 3, the dark cells 5 having a low light reflectance and the bright cells 6 having a high light reflectance are arranged in a lattice pattern. Further, the two-dimensional code 4 includes a predetermined characteristic pattern 7 (finder pattern) used to detect the position of the code and the size of the cell.

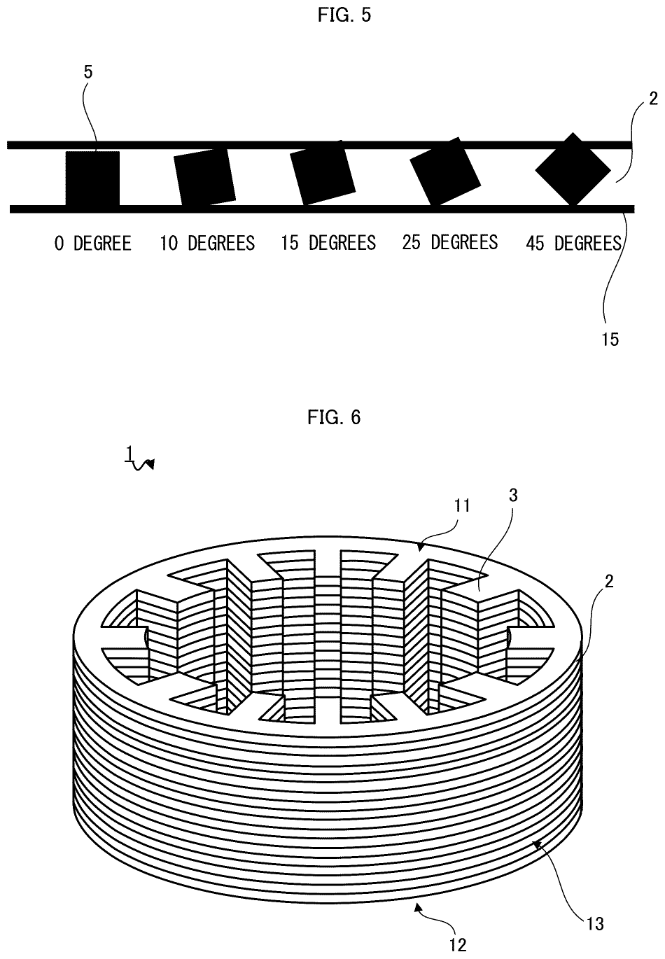

FIG. 4 is a diagram illustrating an example of a two-dimensional code printed in an inclined manner at an angle with respect to streaks formed on the stacked surface. FIG. 5 is a diagram illustrating the positional relationship between the dark cells 5 and the streaks in a case where a two-dimensional code is printed at an angle with respect to the streaks. FIGS. 4 and 5 illustrate examples where the two-dimensional code is printed in a state where one side of a rectangular shape of the two-dimensional code 4 is arranged in an inclined manner at angles of 0 degrees, 10 degrees, 15 degrees, 25 degrees, and 45 degrees with respect to the streaks 15 formed on the stacked surface 13. As illustrated in FIG. 4 and FIG. 5, in a case where the two-dimensional code 4 is printed without making an angle with respect to the streak 15 (at 0 degrees), there are many portions where all sides of the dark cell 5 overlap with the streaks 15. The streak 15 is a portion formed between the thin plate 2 and the thin plate 2 that are stacked with each other, and is recessed or bulged with respect to the stacked surface 13 in a stripe shape. Accordingly, the streaks 15 appear as dark black lines compared to the side portions of the thin plates 2. In a case where the side of the dark cell 5 overlaps with such a portion, it is difficult to identify the position of the profile of the dark cell 5. Accordingly, an error is liable to occur when the two-dimensional code 4 is read. Further, also when the two-dimensional code 4 is printed, a portion is formed in the two-dimensional code 4 where the side of the dark cell 5 cannot be printed sufficiently. On the other hand, by printing the two-dimensional code 4 in an inclined manner at a certain angle with respect to the streaks 15, the sides of the dark cells 5 only partially overlap with the streaks 15. Accordingly, the occurrence of an error at the time of reading the two-dimensional code 4 is reduced. Further, a problem that may occur at the time of printing minimally occurs.

The angle of the two-dimensional code 4 with respect to the streaks 15 may be set to such an extent that the profile of the cell that forms the two-dimensional code 4 is clearly distinguished. This angle changes depending on a length of the side of the cell that forms the two-dimensional code 4 and a thickness of the streak 15 formed on the stacked surface 13. For example, assuming the length of the side of the cell as A [mm], a thickness of the streak 15 as T [mm], and an inclination angle as e [degrees], it has been understood by experiments or the like that an error in reading the two-dimensional code 4 is sufficiently reduced in a case where at least the following expression 1 is satisfied.

$$A sin θ > 2 T \qquad [ Mathematical expression 1 ]$$

In view of such a property, in a case where the cell of the two-dimensional code 4 is sufficiently large, or in a case where a thickness of the streak 15 is small, the inclination of the two-dimensional code 4 with respect to the streak 15 may be set relatively small (for example, approximately 5 degrees to 10 degrees). On the other hand, in a case where the cell of the two-dimensional code 4 is small or in a case where the thickness of the streak 15 is large, it is necessary to increase the inclination of the two-dimensional code 4 with respect to the streak 15 to some extent (for example, 15 degrees or more). The thickness of the streak 15 changes depending on the size of the gap between the thin plates 2, the size of a fracture surface when the thin plate 2 is punched out (the fracture surface appearing black due to reflection of light), and the like. Accordingly, a printing angle of the two-dimensional code 4 may be appropriately changed corresponding to the streaks formed on the stacked surface 13 of the stacked component 1.

For example, a vision sensor is mounted on a laser engraving machine, a robot or the like, and the vision sensor images the stacked surface 13 of the stacked components. Then, a known image analysis is applied to an image of the imaged stacked surface 13 so as to detect the streaks 15 formed on the stacked surface 13. Then, the thickness T of the detected streak 15 is calculated, and the angle θ at which the two-dimensional code 4 is inclined is calculated based on the calculated thickness T of the streak 15 and the length A of the side of the cell of the two-dimensional code 4 to be printed. Then, the two-dimensional code 4 may be printed while inclining the angle of the stacked component with respect to the laser engraving machine based on θ obtained by calculation.

According to the stacked component 1 of the present embodiment described above, at the time of printing the two-dimensional code 4 on the stacked surface 13, it is possible to perform the printing such that the profile of each cell can be clearly distinguished. Further, at the time of reading the two-dimensional code 4 printed on the stacked surface 13, it is possible to reduce the occurrence of an error in reading.

Although the embodiments of the present invention have been described heretofore, the present invention is not limited to only the examples of the above-described embodiments. That is, the present invention can be carried out in various modes by adding appropriate modifications.

### REFERENCE SIGNS LIST

1 stacked component
2 thin plate
3 protruding portion
4 two-dimensional code
5 dark cell
6 bright cell
7 characteristic pattern
11 upper surface
12 lower surface
13 stacked surface
15 streak

1. A stacked component formed by stacking thin plates, wherein
a two-dimensional code is printed on a stacked surface formed by stacking side portions of the thin plates in an inclined manner at a predetermined angle with respect to a stacking direction of the thin plates.

2. The stacked component according to claim 1, wherein
the stacked component is a core block of a stator of an electric motor.

3. The stacked component according to claim 1, wherein
the stacked component is a core block of a rotor of an electric motor.

4. The stacked component according to claim 1, wherein
the stacked component is a core block of a transformer.
